(19) United States
(12) Patent Application Publication
(10) Pub. No.: US 2008/0302427 A1
(43) Pub. Date: Dec. 11, 2008

(54) Vacuum pressure control system

(75) Inventors: Masayuki Watanabe, Kasugai-shi (JP); Makoto Miyahara, Komaki-shi (JP); Shunsuke Umezawa, Kasugai-shi (JP)

Correspondence Address: OLIFF & BERRIDGE, PLC, P.O. BOX 320850, ALEXANDRIA, VA, 22320-4850, US

(73) Assignee: CKD CORPORATION, Komaki-Shi (JP)

(21) Appl. No.: 12/149,658

(22) Filed: May 6, 2008

(30) Foreign Application Priority Data
Jun. 5, 2007 (JP) 2007-149413

(51) Int. Cl. F16K 31/124

(52) U.S. Cl. 137/488

(57) ABSTRACT

A vacuum pressure control system includes a vacuum chamber, a vacuum pump for sucking gas from the vacuum chamber, a vacuum open/close valve for controlling vacuum pressure in the vacuum chamber by changing a opening degree by driving air supplied from an air supply source serving as a power source, a vacuum pressure control device for controlling the vacuum open/close valve, and a servo valve for controlling the opening degree of the vacuum open/close valve.

### BACKGROUND OF THE INVENTION

1. Field of the Invention

The present invention relates to a vacuum pressure control system for maintaining supplied gas at a correct vacuum pressure value in a vacuum container used in a semiconductor manufacturing process and also allowing rapid discharge of the gas out of the vacuum container.

2. Description of Related Art

In a semiconductor manufacturing process, heretofore, various vacuum pressure control systems have been proposed to alternately charge and discharge a process gas and a purge gas in and from a vacuum chamber in which a wafer is disposed. Some of the vacuum pressure control systems are arranged to control flow passage and shutoff of the gasses with an electromagnetic valve and an electro-pneumatic proportion valve in sealing or discharging the gas supplied into the vacuum chamber (see JP9(1997)-72458A).

This vacuum pressure control system disclosed in JP'458A is briefly explained below referring to FIGS. 12 to 15. FIG. 12 is an explanatory view showing a configuration of the vacuum pressure control system. FIG. 13 is a sectional view of a vacuum proportional open/close valve 318 used in the vacuum pressure control system. FIG. 14 is a block diagram to explain a configuration of a control device for controlling the vacuum proportional open/close valve 318. FIG. 15 is a block diagram to explain a timed on/off valve 362.

The vacuum pressure control system of JP'458A includes a vacuum chamber 311, a pressure sensor 317, a vacuum pump 319, a vacuum proportional opening and closing vacuum 318 connected between the vacuum pump 319 and the vacuum chamber 311, and others. In this vacuum proportional open/close valve 318, a piston 341 is actuated by driving air to move a poppet valve element 333 up and down relative to a valve seat 336, causing the presence or absence of a clearance between the poppet valve element 333 and the valve seat 336 to provide a valve opening state or a valve closing state. In this vacuum pressure control system, a first electromagnetic valve 360 for quick air supply and a second electromagnetic valve 361 for quick air discharge are used.

To discharge gas out of the vacuum chamber 311, in this vacuum pressure control system, a first inlet port 611 is connected with an outlet port 613 in the second electromagnetic valve 361 and a second inlet port 602 is connected with an outlet port 603 in the first electromagnetic valve 360, thereby supplying driving air to the vacuum proportional open/close valve 318. Thus, the poppet valve element 333 is opened to allow the gas to be sucked from the vacuum chamber 311 by the vacuum pump 319.

To seal gas in the vacuum chamber 311, on the other hand, a second inlet port 612 is connected with the outlet port 613 in the second electromagnetic valve 361 and the second inlet port 602 is connected with the outlet port 603 in the first electromagnetic valve 360. Thus, no driving air is supplied to the vacuum proportional open/close valve 318 and therefore the poppet valve element 333 is held closed, sealing the gas in the vacuum chamber 311.

In this vacuum pressure control system, when the gas sealed in the vacuum chamber 311 is to be regulated to a target vacuum pressure value from the full open state of the poppet valve element 333 or from the closed state of the poppet valve element 333, the gas is rapidly supplied into or discharged from the vacuum chamber 311 by use of the first and second electromagnetic valves 360 and 361 to change the vacuum pressure to near the target vacuum pressure value. In the vacuum chamber 311 in which the gas is sealed, the vacuum pressure value set as a target value (i.e. a set value) is different from a vacuum pressure value measured by the pressure sensor 317 (i.e. a measured value). Accordingly, additional fine control of the vacuum pressure is conducted.

This fine control of vacuum pressure is made by actuating the timed on/off valve 362 by a vacuum pressure control circuit 367 to adjust the vacuum pressure value (the measured value) in the vacuum chamber 311 to the set value. This timed on/off valve 362 is constituted by a supply-side proportional valve 374 and a discharge-side proportional valve 375 which are 2-port electro-pneumatic proportional valves. Each of these supply-side proportional valve 374 and discharge-side proportional valve 375 has a gas passage with an effective sectional area smaller than that of the first electromagnetic valve 360 and the second electromagnetic valve 361.

An inlet port 374a of the supply-side proportional valve 374 is connected to an air supply source. An outlet port 374b of the valve 374 is connected to an inlet port 375b of the discharge-side proportional valve 375. The outlet port 375a of the discharge-side proportional valve 375 is connected to a discharge side. The inlet port 375b of the discharge-side proportional valve 375 and the outlet port 374b of the supply-side proportional valve 374 are connected respectively to the first inlet port 601 of the first electromagnetic valve 360. The supply-side proportional valve 374 and the discharge-side proportional valve 375 are individually switched to on and off under control of the vacuum pressure control circuit 367. Specifically, they are driven by a pulse voltage applied thereto through a pulse drive circuit 368.

The above configuration makes it possible to stop the piston 341 in a precise position corresponding to a smaller valve opening degree than the opening degree of the poppet valve element 333 for rapid supply and discharge operations through the first and second electromagnetic valves 360 and 361, thereby accurately causing the poppet valve element 333 to open and close at a high response speed. Therefore the gas vacuum pressure could be controlled with high accuracy.

To be concrete, when the measured value of the vacuum pressure in the vacuum chamber 311 is higher than the set value, the amount of driving air to be supplied mainly to the supply-side proportional valve 374 is controlled by discharging part of the driving air from the discharge-side proportional valve 375, thereby moving the poppet valve element 333 through the first electromagnetic valve 360. The poppet valve element 333 is thus moved from a full closed position to a slightly opened position to allow the gas to be sucked from the vacuum chamber 311 until the vacuum pressure becomes the set value.

When the measured value of the vacuum pressure in the vacuum chamber 311 is closer to an absolute vacuum than the set value, on the other hand, most part of driving air is discharged through the discharge-side proportional valve 375 and remaining part of driving air is supplied to the supply-side proportional valve 374 to control the amount of driving air to be supplied to the first electromagnetic valve 360, thereby moving the poppet valve element 333 through the first electromagnetic valve 360. This holds the poppet valve element 333 in a position with a slight clearance relative to the closed position. In this state, the gas is allowed to pass through the vacuum chamber 311 so that the vacuum pressure agrees with the set value.

The conventional vacuum pressure control system such as the vacuum pressure control system of JP'458A has a function of rapidly supplying and discharging gas through an electromagnetic valve, and besides, a function of controlling the vacuum pressure of a process gas supplied and sealed in the vacuum chamber to an exact predetermined vacuum pressure value by the electro-pneumatic proportional valve. Accordingly, if a surface treatment technique using the vacuum pressure control system is conducted for surface treatment on a wafer in a semiconductor manufacturing process, a high accurate surface treatment can be realized.

In this surface treatment technique, on the other hand, the vacuum pressure of the process gas sealed in the vacuum chamber is controlled (fine regulated) precisely by use of the electro-pneumatic valve. It therefore takes over ten seconds to control the vacuum pressure of the process gas to the predetermined vacuum pressure value.

Meanwhile, in the semiconductor manufacturing process, a treatment technique using Atomic Layer Deposition (ALD) process has recently been adopted.

As with conventional surface treatment techniques, this treatment technique using the ALD process is a technique that requires high accurate control of the process gas sealed in the vacuum chamber to the set value. In the treatment technique using the ALD process, different from the conventional surface treatment technique, a required time to discharge a process gas from the vacuum chamber has to be about one or two seconds from introduction of a purge gas in the vacuum chamber.

### BRIEF SUMMARY OF THE INVENTION

In the conventional vacuum pressure control system, however, it would require over ten seconds to regulate the vacuum pressure of process gas to the predetermined vacuum pressure value through the electro-pneumatic proportional valve.

The reason why the above time is required is as below. The stroke of the poppet valve element of the electro-pneumatic proportional valve is determined to be smaller than the stroke of a valve element of the electromagnetic valve and a plunger and an orifice are also designed to be smaller, so that the electro-pneumatic proportional valve can be opened and closed at high frequencies. Accordingly, the flow rate of process gas allowed to flow toward the vacuum chamber can be accurately controlled and hence the vacuum pressure of process gas can be controlled with high precision. On the other hand, in this electro-pneumatic proportional valve, the poppet vacuum element has a short stroke and the plunger and the orifice are small. This allows the process gas to flow therethrough at a smaller flow rate per unit of time for supply or discharge than in the electromagnetic valve. Consequently, it takes longer to allow the process gas to flow in and out of the vacuum chamber, which results in that over ten seconds are required for fine control of vacuum pressure.

As a result, the surface treatment technique using the ALD process for replacing a process gas by a purge gas in one or two seconds could not adopt the conventional vacuum pressure control system. It has been necessary to develop a vacuum pressure control system suitable for a semiconductor manufacturing process using the ALD process and capable of discharging a process gas in short time, for example, one or two seconds from introduction of a purge gas in a vacuum chamber.

The present invention has been made in view of the above circumstances and has an object to provide a vacuum pressure control system to be used in a semiconductor manufacturing process and capable of rapidly maintaining supplied gas at a precise vacuum pressure value and quickly discharging this gas out of a vacuum container.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

(1) To achieve the purpose of the invention, there is provided a vacuum pressure control system comprising: a vacuum container; a vacuum pump for sucking gas from the vacuum container; a vacuum open/close valve connected between the vacuum container and the vacuum pump and adapted to control vacuum pressure in the vacuum container by changing an opening degree by a fluid to be supplied from a fluid supply source serving as a power source; a vacuum pressure control device for controlling the vacuum open/close valve; and a servo valve for controlling the opening degree of vacuum open/close valve.

(2) In the vacuum pressure control system (1), preferably, the servo valve includes a first port connected to the fluid supply source, a second port connected to the vacuum open/close valve, and a third port connected to a discharge passage, and the vacuum pressure control device is adapted to store, as a zero command signal value, a servo valve command value at which a difference between a flow rate of the fluid flowing from the first port to the second port and a flow rate of the fluid flowing from the second port to the third port becomes zero.

(3) The vacuum pressure control system (2) preferably includes a teaching program for detecting the zero command signal value when the vacuum pressure control system is installed in a production line where the system will be actually operated.

(4) In the vacuum pressure control system (3), preferably, the vacuum pressure control device is adapted to output the servo valve command signal based on the stored zero command signal value to control the servo valve.

(5) In the vacuum pressure control system (1), preferably, the vacuum open/close valve includes: a valve seat; a valve element that is movable into or out of contact with the valve seat by the fluid supplied from the fluid supply source to change the opening degree in valve opening and closing directions; and an elastic member that urges the valve element to the valve closing side, the opening degree is changed by a minimum pressing force of the fluid required to overcome an urging force of the elastic member.

(6) The vacuum pressure control system (1) preferably comprises a fluid passage stop valve for stopping the fluid from flowing from the fluid supply source into the servo valve when the vacuum pressure control system is in an nonoperating state.

(7) In the vacuum pressure control system (1), preferably, the vacuum open/close valve includes a valve opening adjustment part for manually controlling the opening degree of the vacuum open/close valve without use of the servo valve.

(8) The vacuum pressure control system (1) preferably includes a displacement sensor for measuring the opening degree of the vacuum open/close valve in noncontact relation.

(9) In the vacuum pressure control system (1), preferably, the vacuum open/close valve includes: a valve seat; a valve element that is movable into or out of contact with the valve seat: an actuator for moving the valve element according to the fluid supplied from the fluid supply source; and a pressure sensor for measuring internal pressure of the actuator.

Some servo valves are generally configured for example such that a first port for allowing the inflow of a fluid in a servo valve, a second port for allowing the outflow of a fluid at a controlled flow rate toward a supply destination, a third port for allowing discharge of the fluid out of the servo valve, and others. Such servo valves configured as above include a specific servo valve for example provided with two coils having opposite energization directions, a spool having a magnet, and so on. In this servo valve, upon energization of one of the coils, an electromagnetic force occurring in this coil and a magnetic force of the magnet cause a valve element to move in one of stroke directions in a cylinder and exactly stop at a position corresponding to an energization amount. Upon energization of the other coil, on the other hand, an electromagnetic force occurring in this coil and the magnetic force of the magnet cause the valve element to move in the other stroke direction in the cylinder and exactly stop at a position corresponding to an energization amount.

Accordingly, when a control part of the servo valve receives a command signal to appropriately control the energization amounts to both coils from a control device, the valve element is actuated rapidly and with high response in the stroke directions in a valve based on this command signal and is accurately stopped at a predetermined position.

In such a servo valve, the valve element is movable in the valve in the stroke directions, that is, along a direction of arrangement of the first port and the third port in section, via the second port therebetween.

When the valve element is stopped at one end position in the stroke direction in the cylinder, a passage of the third port is shut off and a passage of the first port is fully opened. The fluid flowing in the first port is therefore allowed to rapidly flow to the supply destination through the second port. Further, when the valve element is stopped at the other end position in the stroke direction, the passage of the first port is shut off and a passage of the third port is fully opened. The fluid flowing in the second port is thus allowed to rapidly flow out of the servo valve through the third port.

In the servo valve, moreover, the valve element is also allowed to stop at a neutral position between the passage of the first port and the passage of the third port to precisely block parts of the respective passages. This makes it possible to finely control a flow rate of a fluid allowed to flow from the first port to the second port and a flow rate of a fluid allowed to flow from the second port to the third port at high response speed and with high accuracy by for example slightly increasing a passage communicating between the first port and the second port or a passage communicating between the second port and the third port.

In the vacuum pressure control system of the invention, the opening degree of the vacuum open/close valve is changed by a fluid supplied from a fluid supply source in order to control vacuum pressure in a vacuum container. This control of opening degree of the vacuum open/close valve is performed by a servo valve.

The servo valve allows a fluid flowing in the first port to rapidly flow to a supply destination through the second port and allows a fluid flowing through the second port to rapidly flow out through the third port with high response and high accuracy as mentioned above. It is further possible to finely control the flow rate of the fluid flowing from the first port to the second port and the flow rate of the fluid flowing from the second port to the third port with high response and high accuracy.

Accordingly, when the fluid causing a change in opening degree of the vacuum open/close valve is controlled by the servo valve, rapid supply of gas into a vacuum container and rapid discharge of the gas from the vacuum container can be conducted appropriately. The fine control of flow rates between a supply amount of gas to be supplied to the vacuum container and a discharge amount of the gas to be discharged from the vacuum container can also be achieved rapidly and accurately.

In the conventional vacuum pressure control system, it would take over ten seconds to rapidly supply and discharge gas by an electromagnetic valve and finely control the vacuum pressure of gas in the vacuum container by an electro-pneumatic proportional valve having a poppet valve which is opened and closed at high frequencies. In the vacuum pressure control system of the invention, on the other hand, a required time to discharge a process gas can be one or two seconds from introduction of a purge gas in the vacuum container.

The vacuum pressure control system of the invention can therefore maintain the supplied gas at a correct vacuum pressure value and rapidly discharge the gas out of the vacuum container. For example, it can be achieved as a system suitable for a semiconductor manufacturing process using the ALD process which requires discharging of a process gas in one or two seconds from introduction of a purge gas in a vacuum chamber.

Meanwhile, in the servo valve, the valve element such as a spool is moved to slide within a cylinder and stopped at a predetermined position based on a command signal. In the servo valve, accordingly, a slight clearance is provided between the outer periphery of the valve element and the inner periphery of the cylinder.

The presence of such clearance may cause the following problems. For example, even when a command signal for closing the vacuum open/close valve is input to the servo valve and the valve element is exactly stopped at a position to close the passage communicating between the first and second ports and the passage communicating between the second and third ports respectively, the fluid leaking from the first port through the clearance may flow in the second port. Then, the vacuum open/close valve could not be fully closed and is brought into an open state by the fluid leaking in the second port. Or the fluid leaking from the second port through the clearance may flow in the third port. The vacuum open/close valve would be opened by the fluid leaking in the third port even when the vacuum open/close valve needs to be closed to keep the gas in a sealed condition at a predetermined vacuum pressure value in the vacuum container.

In the case where the opening degree of the vacuum open/close valve is controlled by the servo valve, as mentioned above, the fluid is liable to enter the clearance between the outer periphery of the valve element and the inner periphery of the cylinder in the servo valve even when a command signal to close the vacuum open/close valve is transmitted to the servo valve. The fluid leakage amount at that time is so small as not to cause any problem in use as a normal valve.

However, in the vacuum pressure control system, the vacuum open/close valve is opened and closed by actuation of for example the piston or the like. Sliding resistance of the piston is low to enhance a response speed in opening and closing the vacuum open/close valve. Accordingly, even if the leaked fluid is just a small amount in the servo valve, the piston is caused to move by the leaked fluid. This would cause the vacuum open/close valve to open instantaneously at the start of control, sucking the gas from the vacuum container by the vacuum pump, leading to a decrease in vacuum pressure of the gas (a change in vacuum pressure value to a higher vacuum side), or the vacuum open/close valve to repeat opening and closing at relatively high frequencies than necessary and hence the opening degree of the vacuum open/close valve could not be controlled accurately. As a result, a problem may occur that the vacuum pressure of the gas sealed in the vacuum container could not be controlled to accurately coincide with a predetermined vacuum pressure value.

In the vacuum pressure control system of the invention, on the contrary, the vacuum pressure control device is adapted to control a difference between the flow rate of a fluid flowing from the first port to the second port and the flow rate of a fluid flowing from the second port to the third port based on the servo valve command signal outputted to the servo valve, and detect a value at which the opening degree is changed from the full closed position to a predetermined opening degree and store it as the servo valve command signal. The vacuum pressure control system further includes a teaching program for controlling the operation of the servo valve based on this servo valve command signal.

In this vacuum open/close valve, a difference between the flow rate of a fluid flowing from the second port of the servo valve into the vacuum open/close valve and the flow rate of a fluid flowing from the vacuum open/close valve into the second port is controlled in advance. After the vacuum open/close valve is placed in a valve closed state, the operation of the servo valve is controlled based on the servo valve command signal obtained when the vacuum open/close valve is adjusted to a predetermined opening degree. Even if the fluid leaks through a clearance between the outer periphery of a valve element and the inner surface of the cylinder in the servo valve, the opening degree of the vacuum open/close valve can be controlled accurately. Accordingly, the vacuum open/close valve can be brought into a valve open state with high accuracy and precise position.

In the case where the vacuum pressure control system of the invention is installed in a factory or plant, for example, the use environment of the system such as pipe length and pipe diameter for flowing the driving air AR from the air supply source to the servo valve and the amount of driving air AR to be supplied from the air supply source to equipment other than the vacuum pressure control system differs depending on usage purposes. Accordingly, the amount of driving air AR leaking within the servo valve is different between the systems according to the usage purposes. The reference valve position of the vacuum open/close valve is slightly different between the systems.

However, in the vacuum pressure control system of the invention, the vacuum pressure control device includes a teaching program.

Accordingly, even after the vacuum pressure control system is installed in a production line or the like in a factory or plant where the system is actually operated, an optimum servo valve command signal suitable for the use environment of the system can be detected and stored prior to actual operation so that an adequate operating condition of the vacuum pressure control system is obtained in advance under the same condition as in the actual operation.

To change the opening degree of the vacuum open/close valve, the fluid pressure has only to meet a minimum required pressure value (a required pressure value) for controlling the opening degree of the vacuum open/close valve. Some of the vacuum open/close valves may cause no problem in control of the opening degree even though the fluid pressure is larger than the required pressure value.

When the opening degree of the vacuum open/close valve is controlled toward the closing side, for example, when the valve is to be closed from the maximum opening degree, it will take more time than necessary to reduce the pressure of fluid from the supply pressure value to the required pressure value if a fluid of larger pressure than the required pressure value is supplied to such vacuum open/close valve.

In the vacuum pressure control system of the invention, on the contrary, the vacuum open/close valve includes: a valve seat; a valve element that is movable into or out of contact with the valve seat by the fluid supplied from the fluid supply source to change the opening degree in valve opening and closing directions; and an elastic member that urges the valve element to the valve closing side. In this system, the opening degree of the vacuum open/close valve is changed by a minimum pressing force of the fluid required to overcome the urging force of the elastic member. It is thus possible to rapidly reduce the fluid pressure so that the urging force of the elastic member becomes larger than the pressing force of the fluid. Consequently, the opening degree of the vacuum open/close valve can be controlled quickly to the closing side.

As mentioned above, a slight clearance exists between the valve element of the spool or the like built in the servo valve and an inner periphery of a cylinder surrounding the valve element. This may cause outside leakage of a fluid through this clearance.

If the fluid is being supplied from the supply source to the servo valve even when the servo valve does not need fluid supply such as when the vacuum pressure control system is not operated, the fluid will be wasted through this clearance.

On the other hand, the vacuum pressure control system of the invention further includes a fluid passage stop valve for stopping the fluid from flowing from the fluid supply source into the servo valve when the vacuum pressure control system is in an nonoperating state. Accordingly, while the vacuum pressure control system is not being operated, the supply of fluid to the servo valve can be completely shut off. In this state, it is possible to prevent wasteful consumption of the fluid.

In the vacuum pressure control system of the invention, preferably, the vacuum open/close valve includes a valve opening adjustment part for manually controlling the opening degree of the vacuum open/close valve without use of the servo valve. In the case where maintenance of the vacuum pressure control system is conducted, for example, the valve opening control part has only to be operated to easily change the opening degree of the vacuum open/close valve.

The vacuum pressure control system of the invention preferably includes a displacement sensor for measuring the opening degree of the vacuum open/close valve in noncontact relation. In measuring the vacuum opening degree of the open/close valve, friction resulting from the contact between part of the displacement sensor and the vacuum valve will not occur. Thus, a trouble due to contact failure of the displacement sensor will not be caused by abrasion powder resulting from friction. Accordingly, the valve opening degree VL of the vacuum open/close valve can be measured appropriately by the displacement sensor.

In the vacuum pressure control system of the invention, preferably, the vacuum open/close valve includes: a valve seat; a valve element that is movable into or out of contact with the valve seat: an actuator for moving the valve element according to the fluid supplied from the fluid supply source; and a pressure sensor for measuring internal pressure of the actuator. This pressure sensor can serve to check whether or not driving air for driving the actuator is supplied from the air supply source to the air chamber. Additionally, the pressure signal representing the pressure of the fluid for driving the actuator is detected by the pressure sensor and fed back to the vacuum pressure control device. Based on this pressure signal, the vacuum pressure control device appropriately corrects the command signal to be applied to the servo valve. Accordingly, the servo valve can be controlled adequately even where the pressure of the fluid varies without adversely affecting the control of the vacuum open/close valve. The opening degree of the vacuum open/close valve can therefore be controlled appropriately.

The actuator may include for example a piston to be driven for changing the opening degree of the vacuum open/close valve by the fluid supplied to a fluid chamber of the vacuum open/close valve. As to such an actuator, the actuator internal pressure indicates the internal pressure in the fluid chamber.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is an explanatory view showing a configuration of a vacuum pressure control system in a preferred embodiment;

FIG. 2 is a block diagram showing the configuration of a vacuum pressure control system in the embodiment;

FIG. 3 is a block diagram showing a control method in a valve opening position control circuit of a system controller of a vacuum pressure control apparatus in the embodiment;

FIG. 4 is a sectional view of a vacuum open/close valve in a closed state in the embodiment;

FIG. 5 is a side view of the vacuum open/close valve in the embodiment;

FIG. 6 is a sectional view of the vacuum open/close valve in an open state in the embodiment;

FIG. 7 is an explanatory view showing a configuration of a servo valve used in the vacuum pressure control system in the embodiment;

FIG. 8 is a graph showing flow rate characteristics based on a relationship between command voltage for controlling a position of a spool in the servo valve and a flow direction and flow rate of driving air;

FIG. 9 is a flowchart showing a technique of controlling operation of the servo valve according to a teaching program configured in the vacuum pressure control apparatus in the embodiment;

FIG. 10 is a graph showing results of a first examination;

FIG. 11A is a graph showing results of the first examination in which a valve is moved from a full open position;

FIG. 11B is a graph showing results of the first examination in which the valve is moved from a closed position;

FIG. 12 is an explanatory view showing a configuration of a conventional vacuum pressure control system;

FIG. 13 is a sectional view of a vacuum proportional open/close valve used in the conventional vacuum pressure control system;

FIG. 14 is a block diagram showing valve control of a vacuum proportional open/close valve in the conventional vacuum pressure control system;

FIG. 15 is a block diagram showing valve control of the vacuum proportional open/close valve in the conventional vacuum pressure control system;

FIG. 16 is a view showing the servo valve in a stop state in the embodiment.

### DETAILED DESCRIPTION OF THE PREFERRED EMBODIMENTS

A detailed description of a preferred embodiment of a vacuum pressure control system embodying the present invention will now be given referring to the accompanying drawings.

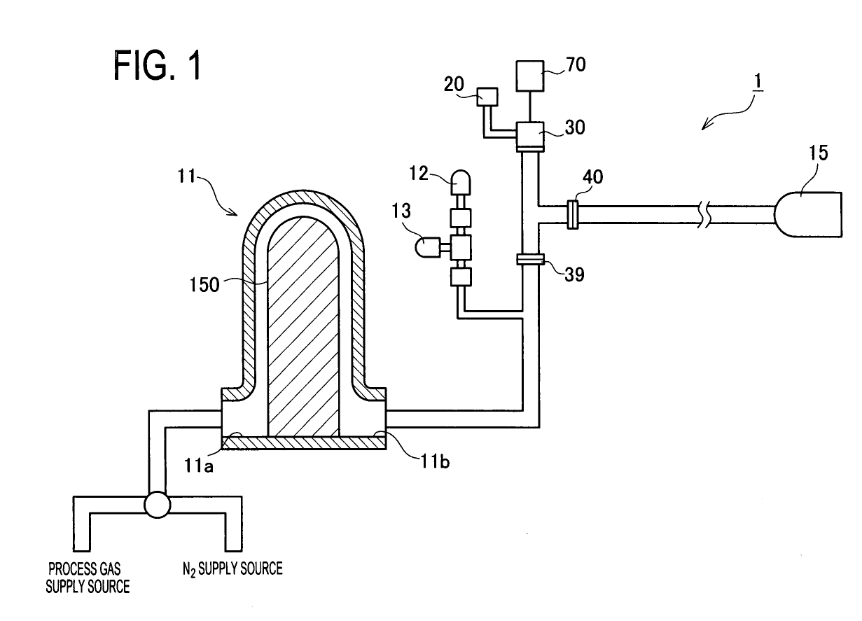

FIG. 1 is an explanatory view showing a configuration of a vacuum pressure control system 1 in the present embodiment. This system 1 is arranged to supply and discharge a process gas and a purge gas alternately in and out of a vacuum chamber 1 in which a wafer 150 is set, for surface treatment on the wafer 150 in a semiconductor manufacturing process.

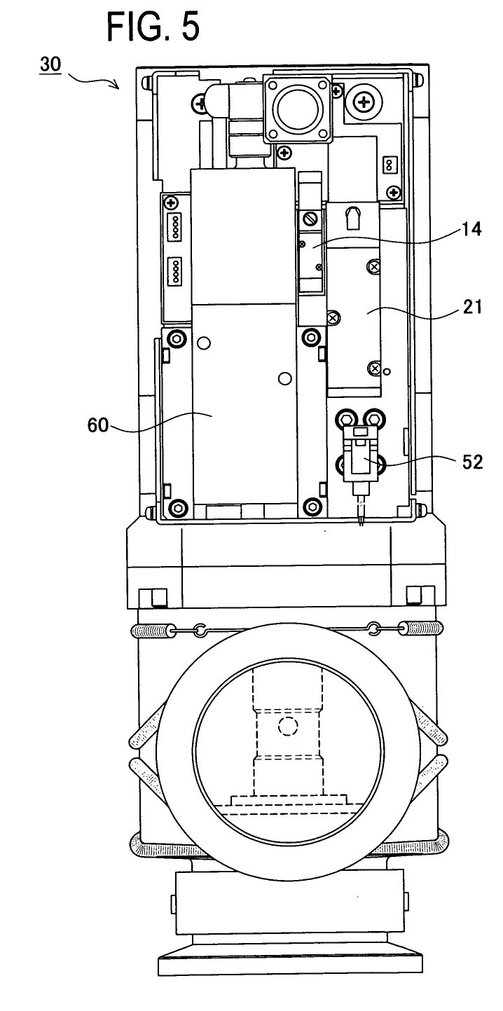

The vacuum pressure control system 1 is constituted mainly by the vacuum chamber 11, a vacuum pump 15, an air supply source 20 (a fluid supply source), a vacuum open/close valve 30 (hereinafter, “open/close valve 30”), a servo valve 60 (see FIG. 5), a vacuum pressure control device 70 electrically connected to the open/close valve 30 and others, as shown in FIG. 1. In this system 1, driving air AR which is supplied from the air supply source 20 is used as a fluid serving as power for opening and closing the open/close valve 30.

To a gas inlet 11a of the vacuum chamber 11, a supply source of process gas to be used for surface treatment on the wafer 150 set in the vacuum chamber 11 and a supply source of nitrogen gas to be used for purging the process gas from the vacuum chamber 11 are connected in parallel.

A first port 39 of the open/close valve 30 which will be mentioned later is connected to a gas outlet 11b of the vacuum chamber 11. This open/close valve 30 is coupled to the air supply source 20 by piping via a stop valve 21 serving as a fluid flow stop valve and a hand valve 14 serving as a valve opening adjustment part (see FIG. 5) which are connected to the open/close valve 30. A pressure sensor 12 for chamber is connected, via a shutoff valve 13, to a passage provided between the gas outlet 11b and the open/close valve 30. This pressure sensor 12 is electrically connected to a vacuum pressure control circuit 83 mentioned later in the vacuum pressure control device 70. A second port 40 of this valve 30 is communicated with the vacuum pump 15.

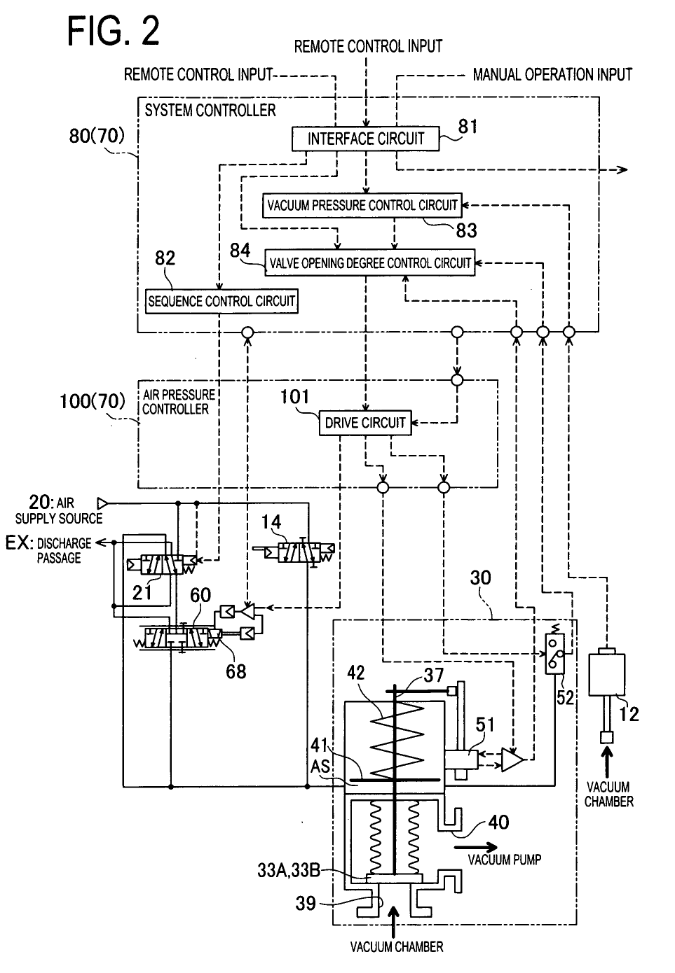

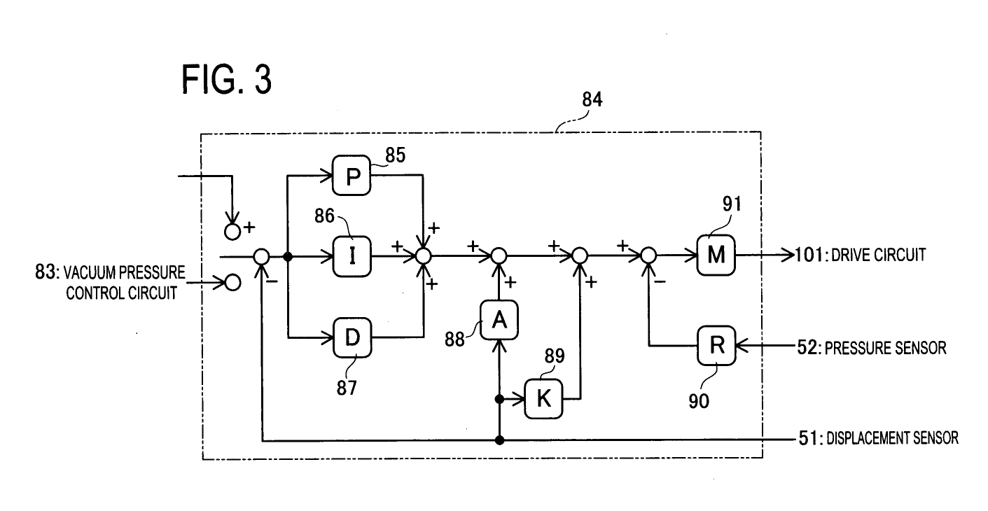

Firstly, the vacuum pressure control device 70 is explained below referring to FIGS. 2 and 3. FIG. 2 is a block diagram showing the configuration of the vacuum pressure control device 70. FIG. 3 is a block diagram to explain a control method of a valve opening degree control circuit 84 in a system controller 80 of the vacuum pressure control device 70.

This vacuum pressure control device 70 includes the system controller 80 and an air pressure controller 100, and also a microcomputer (not shown) having well known configurations such as a CPU, a ROM, and a RAM. The microcomputer is arranged such that a teaching program mentioned later and other programs stored in the ROM and others are loaded in the CPU to execute predetermined operations such as actuation of the servo valve 60 and others and controls of vacuum pressure of process gas in the vacuum chamber 11.

The system controller 80 further includes an interface circuit 81, a sequence control circuit 82, a vacuum pressure control circuit 83, and a valve opening degree control circuit 84 and is also connected to the microcomputer. The interface circuit 81 is connected to the sequence circuit 82 and the vacuum pressure control circuit 83. This vacuum pressure control circuit 83 is connected to a drive circuit 101 of the air pressure controller 100 via the valve opening degree control circuit 84.

Of the system controller 80, the valve opening degree control circuit 84 includes a proportional circuit 85, an integration circuit 86, and a differentiation circuit 87, which are connected in parallel to the vacuum pressure control circuit 83, a piston acceleration control circuit 88, a piston operation control circuit 89, a vacuum open/close valve internal pressure feedback control circuit 90, and a servo valve drive correction control circuit 91. The valve opening degree control circuit 84 is controlled by the microcomputer.

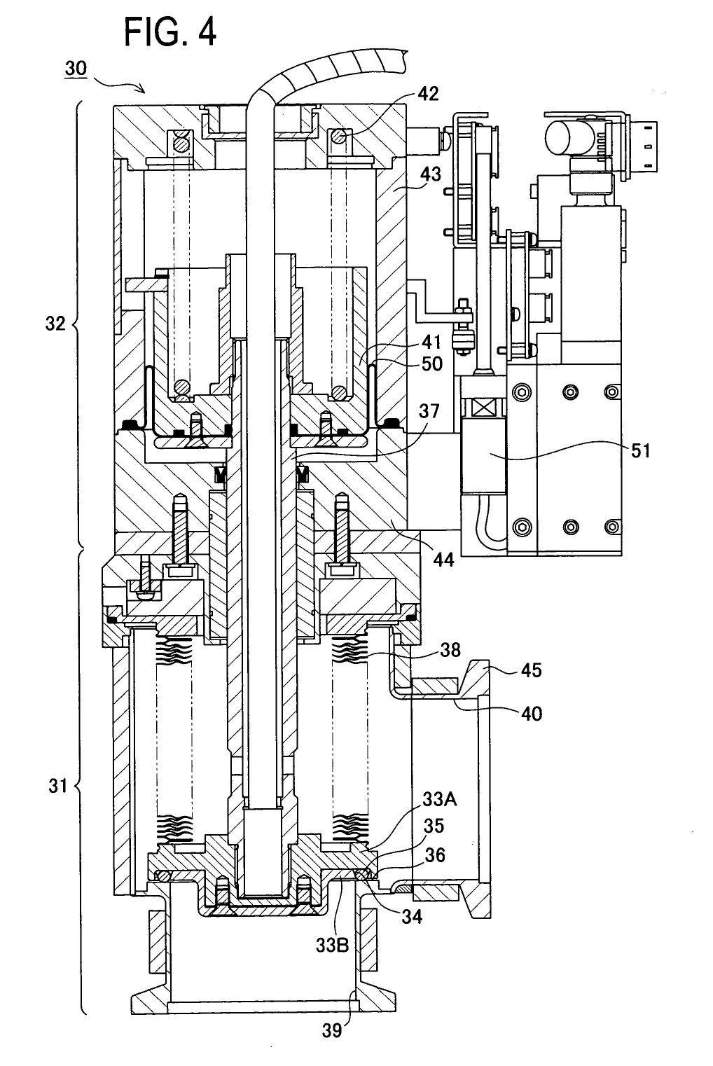

In the valve opening degree control circuit 84, a difference between a displacement detecting signal outputted from a displacement sensor 51 mentioned later (see FIG. 4) and a control signal outputted from the higher-level interface circuit 81 or vacuum pressure control circuit 83 is inputted in the proportional circuit 85, the integration circuit 86, and the differentiation circuit 87. This displacement detecting signal is also inputted in an output side of those proportional circuit 85, integration circuit 86, and differentiation circuit 87 through the piston acceleration control circuit 88 and also inputted in an output side of the piston acceleration control circuit 88 through the piston operation control circuit 89. Moreover, a pressure detecting signal representing the pressure in an air chamber AS of the open/close valve 30 outputted by an open/close valve pressure sensor 52 is similarly inputted in the output side of the piston operation control circuit 89 and the piston acceleration control circuit 88 through the vacuum open/close valve internal pressure feedback control circuit 90. Output signals from the piston acceleration control circuit 88, the piston operation control circuit 89, and the vacuum open/close valve internal pressure feedback control circuit 90 are inputted and corrected in a servo valve drive correction circuit 91. After correction, this servo valve drive correction circuit 91, that is, the valve opening degree control circuit 84 outputs a valve opening degree control signal to the drive circuit 101 of the air pressure controller 100.

The piston acceleration control circuit 88 is a circuit for restricting the level of acceleration to prevent the acceleration of the piston 41 in operation from increasing higher than necessary. The presence of this piston acceleration control circuit 88 can restrain defects such as damages and premature deterioration resulting from that bellows 38 and a bellofram 50 move at a speed higher than necessary in association with the operation of the piston 41.

The piston operation control circuit 89 is a circuit for electrically correcting response characteristics of a return spring 42 of the open/close valve 30. More specifically, in the open/close valve 30, the piston 41 is movable toward a valve opening side in a valve lift direction against an urging force of the return spring 42. Therefore, even when the pressing force of the driving air AR toward the valve opening side is larger than the urging force of the return spring 42, the return spring 42 does not tend to linearly respond (contract) to the pressing force because of its spring characteristics. Thus, the open/close valve 30 is not allowed to be opened at an accurate valve opening degree VL based on an appropriate pressing force. The piston operation control circuit 89 is configured to apply a bias value in order to make linear control of the balance between the pressing force of the driving air AR and the urging force of the return spring 42. It is to be noted that in this embodiment the “valve opening side” indicates an upper side in the figure and the “valve closing side” indicates a lower side in the figure.

The servo valve drive correction control circuit 91 is a circuit for correcting the valve opening degree control signal to a teaching command voltage value obtained under the teaching program, as command voltage to be applied to the control part 68 of the servo valve 60.

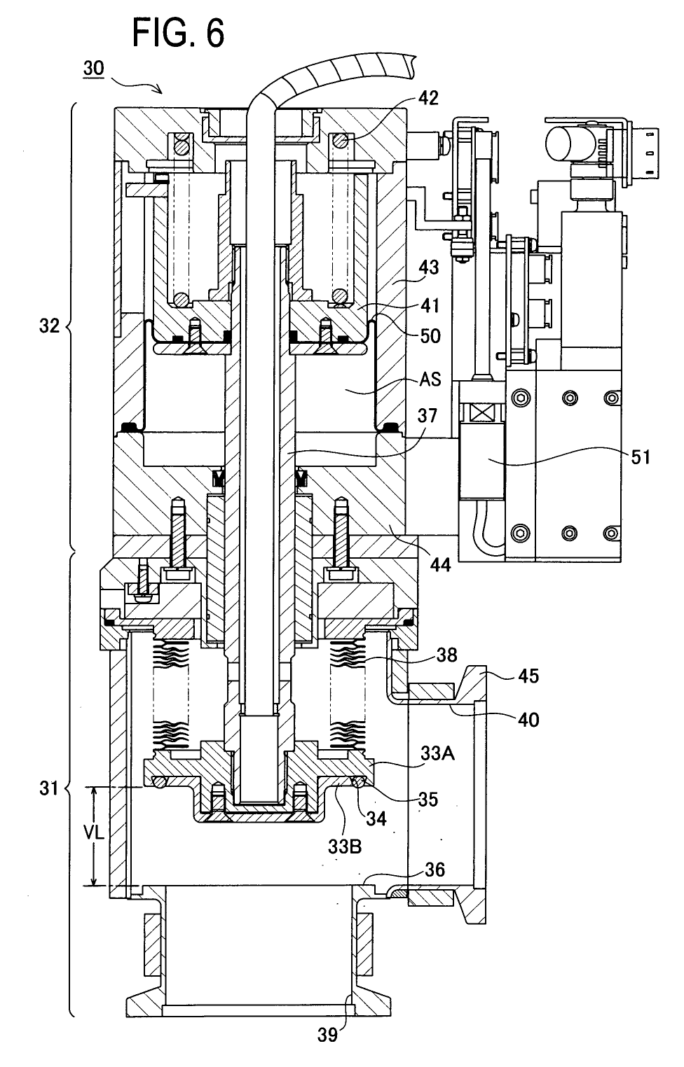

The open/close valve 30 will be explained below referring to FIGS. 2 and 4-6. FIG. 4 is a sectional view of the open/close valve 30 in a closed state. FIG. 5 is a side view of the valve 30 of FIG. 4. FIG. 6 is a sectional view of the valve 30 in an open state.

The open/close valve 30 is constituted by a pilot cylinder section 32 placed on a valve opening side (an upper side in FIGS. 4 and 6) in the lifting direction (a vertical direction in FIGS. 4 and 6) of a poppet valve 33A movable up and down to open and close and a bellows poppet valve section 31 placed on a valve closing side (a lower side in FIGS. 4 and 6).

The pilot cylinder section 32 further includes the piston 41 (an actuator), the return spring 42, a single-acting pneumatic cylinder 43, the bellofram 50, the displacement sensor 51, and others. On the other hand, the bellows poppet valve section 31 includes the poppet valve element 33A, an O-ring holder 33B, the valve seat 36, the bellows 38, the first port 39 communicated with the vacuum chamber 11, the second port 40 communicated with the vacuum pump 15, and others.

In the pilot cylinder section 32, the piston 41 is urged toward the valve closing side in the valve lifting direction by the return spring 42. This piston 41 is disposed to be movable in the valve lifting direction within the single-acting pneumatic cylinder 43 while the bellofram 50 is provided between the piston 41 and the cylinder 43. This piston 41 is arranged to move within the cylinder 43 through the bellofram 50 and hence the piston 41 will not cause stick-slip motion. Accordingly, the piston 41 is able to move within the cylinder 43 with high response and exact positional accuracy.

The pilot cylinder section 32 is further provided with the displacement sensor 51 (see FIG. 2) for measuring in noncontact relation a displacement amount of the piston 41 corresponding to a moving distance from a lower dead center of the piston 41 when the piston 41 is moved in the valve lifting direction, that is, the opening degree VL of the open/close valve 30. This displacement sensor 51 is electrically connected to the valve opening degree control circuit 84 of the system controller 80 and the drive circuit 101 of the air pressure controller 100 in the vacuum pressure control device 70.

The bellofram 50 is a diaphragm of a bottom-closed cylindrical shape made by cloth such as polyester, polyamide, and aramid, integrally molded into a rubber material. A center portion of this bellofram 50 is fixed to an end of the piston 41 on the valve closing side (i.e., a bottom of the piston 41 in FIG. 4). A peripheral portion of the bellofram 50 is fixed to a cylinder wall 44. The bellofram 50 is deeply folded near the cylinder wall 44. The thus configured bellofram 50 has a stroke in the valve lifting direction to follow the movement of the piston 41 to the valve opening side. When the driving air AR is supplied into between the piston 41 and the cylinder wall 44 in the valve lifting direction, i.e., the air chamber AS shown in FIG. 6, the bellofram 50 maintains a constant effective pressure area with respect to the driving air AR.

This air chamber AS is provided with the open/close valve pressure sensor 52 (see FIG. 5) for measuring the pressure of the driving air AR supplied to the chamber AS. This pressure sensor 52 is electrically connected to the valve opening degree control circuit 84 of the system controller 80 and the drive circuit 101 of the air pressure controller 100 in the vacuum pressure control device 70.

In the vacuum pressure control system 1 of this embodiment, a minimum supply pressure value of the driving air AR required for driving the piston 41 to control the valve opening degree VL of the open/close valve 30 is set to 0.35 MPa as a measured value of the open/close valve pressure sensor 52. In other words, when the supply pressure of the driving air AR supplied to the air chamber AS is 0.35 MPa or more, the piston 41 is moved to the valve opening side in the valve lifting direction against the urging force of the return spring 42. To the contrary, when the supply pressure of the driving air AR is smaller than 0.35 MPa, the pressing force of the driving air AR in a valve opening direction is lower than the urging force of the return spring 42 and therefore the piston 41 is not moved to the valve opening side.

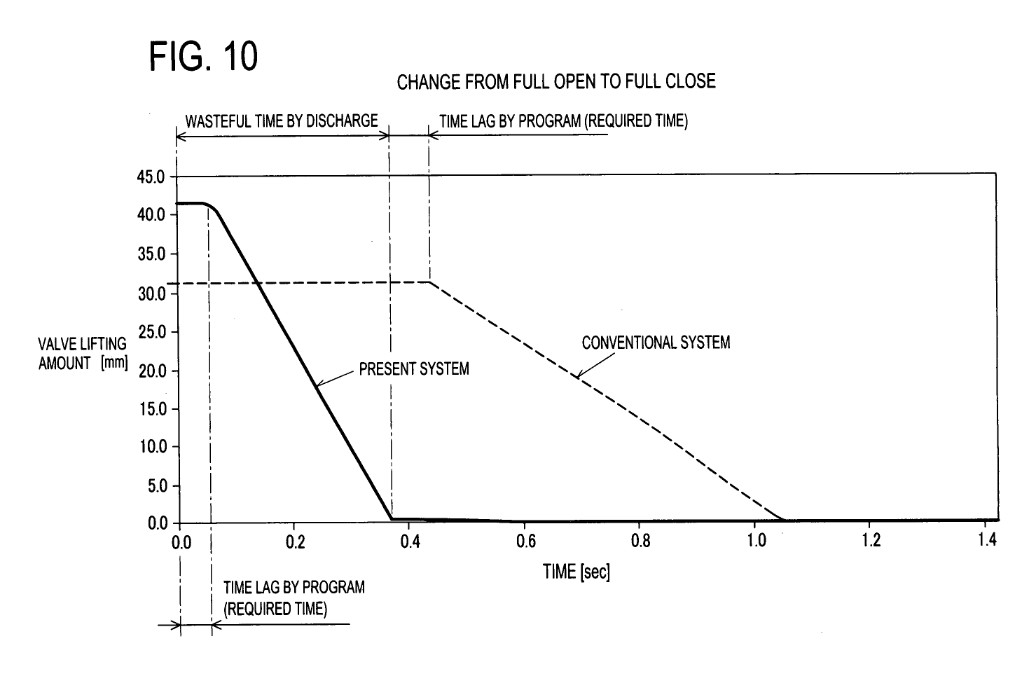

In the vacuum pressure control system 1 of this embodiment, accordingly, the valve opening degree VL of the open/close valve 30 is controlled to change by the minimum pressing force of the driving air AR (supply pressure: 0.35 MPa) required to overcome the urging force of the return spring 42. This makes it possible to rapidly reduce the pressure of the driving air AR so that the urging force of the return spring 42 overcomes the pressing force of the driving air AR. Consequently, the valve opening degree VL of the open/close valve 30 can be controlled toward the valve closing side quickly (see FIG. 10).

A piston rod 37 is fixedly provided at the center of the piston 41 in the radial direction. This piston rod 37 is movable together with the piston 41 in the same valve lifting direction. Specifically, the piston rod 37 is placed extending into the bellows poppet valve section 31 and an end of the piston rod 37 (a lower end in the figure) is connected with the poppet valve element 33A. The bellows 38 is fixed at its one end in the axial direction to the poppet valve element 33A to surround the piston rod 37 from outside in a radial direction. The bellows 38 will expand and contract in association with the movement of the poppet valve element 33A in the valve lifting direction.

The poppet valve element 33A and the O-ring holder 33B are fixed to each other on the valve closing side of the poppet valve element 33A (i.e., the bottom thereof). An O-ring mounting part 34 is provided in a clearance between the poppet valve element 33A and the O-ring holder 33B. An O-ring 35 is fitted in the O-ring mounting part 34 to come into contact with the valve seat 36.

In the vacuum pressure control system 1, the poppet valve element 33A is urged by the return spring 42 via the piston 41 toward the valve closing side in the valve lifting direction. Accordingly, when the driving air AR is not supplied from the air supply source 20 to the air chamber AS, the O-ring 35 is pressed between the poppet valve element 33A and the valve seat 36. Thus, the first port 39 is closed by the poppet valve element 33A, placing the open/close valve 30 in a valve closed state (the opening degree VL=0).

When the driving air AR is supplied to the air chamber AS, on the other hand, the poppet valve element 33A is moved toward the valve opening side in the valve lifting direction against the urging force of the return spring 42 through the piston 41. When the poppet valve element 33A is moved to the valve opening side, bringing the O-ring 35 out of contact with the valve seat 36, thus allowing communication between the first port 39 and the second port 40, the open/close valve 30 is placed in a valve open state (the opening degree VL>0). Thus, a process gas or nitrogen gas will be sucked from the vacuum chamber 11 by the vacuum pump 15.

The hand valve 14 is connected between the air chamber AS of the open/close valve 30 and the air supply source 20. This hand valve 14 is manually operated, separately from the servo valve 60, to introduce the driving air AR into the air chamber AS and to discharge the driving air AR from the air chamber AS.

When maintenance of the vacuum pressure control system 1 is to be performed, for example, the hand valve 14 can be operated to perform intake/discharge of the driving air AR with respect to the air chamber AS. Accordingly, the open/close valve 30 can easily be opened and closed without use of the servo valve 60. This makes it possible to enhance workability in maintenance as compared with the case where the open/close valve 30 is opened and closed with use of the servo valve 60.

The vacuum pressure control system 1 is provided with the stop valve 21 (FIG. 2) as mentioned above. An inlet side of this valve 21 is connected to the air supply source 20, a discharge passage EX, and the air chamber AS of the open/close valve 30 respectively. An outlet side of the valve 21 is connected to the first port 61 and the third port 63 of the servo valve 60. This stop valve 21 is a 5-port valve configured to be switchable to block the flow of the driving air AR from a port connected on the inlet side to the air supply source 20 to a port connected on the outlet side to the first port 61 of the servo valve 60. The stop valve 21 is electrically connected to the sequence circuit 82 of the system controller 80 in the vacuum pressure control device 70.

When the driving air AR does not need to be supplied to the servo valve 60, for example, during non-operation of the vacuum pressure control system 1, but the driving air AR is being supplied from the air supply source 20 toward the servo valve 60, the stop valve 21 shuts off the flow of the driving air AR toward the servo valve 60. It is therefore possible to prevent wasteful consumption of the driving air AR in the servo valve 60.

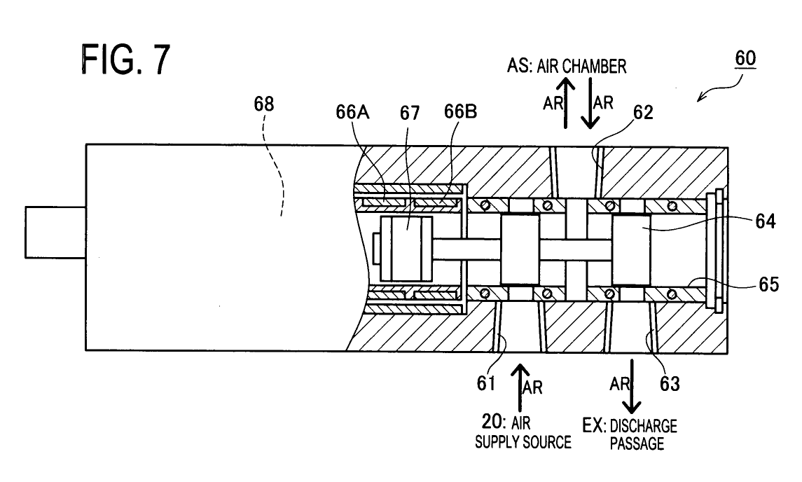

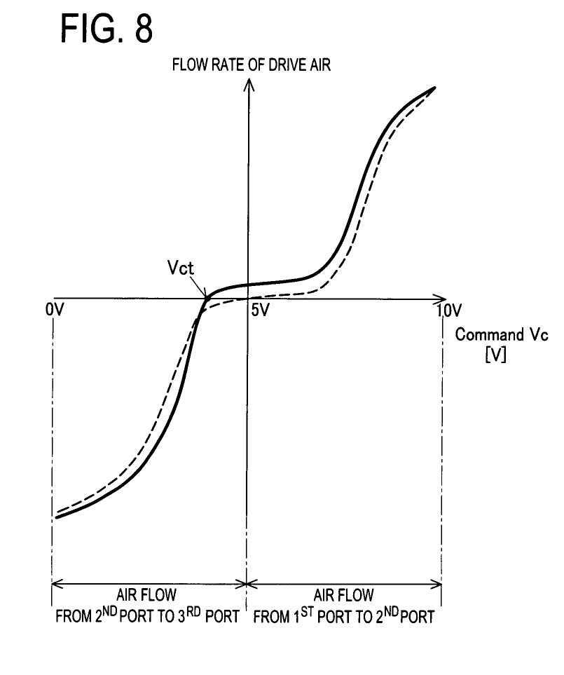

The servo valve 60 will be explained below referring to FIGS. 7 and 8. FIG. 7 is explanatory view showing a configuration of the servo valve 60. FIG. 8 is a graph showing flow rate characteristics based on a relationship between command voltage for controlling the position of a spool 64 in the servo valve 60 and a flow direction and flow rate of the driving air AR. In FIG. 7, a dotted line indicates the flow rate characteristics in the case where leakage of the driving air AR between the first, second, and third ports 61, 62, and 63 is not count and a sold line indicates the flow rate characteristics in the case where the servo valve 60 is controlled under the teaching program.

This servo valve 60 includes the first port 61 connected to the air supply source 20 via the stop valve 21, the second port 62 connected to the air chamber AS of the open/close valve 30, and the third port 63 connected to the discharge passage EX via the stop valve 21 (see FIG. 2). The second port 62 is located between the first and third ports 61 and 63 in a stroke direction (a lateral direction in FIG. 7) of the servo valve 60. The servo valve 60 includes a cylinder 65, a first coil 66A and a second coil 66B which are energized in opposite directions to each other, the spool 64 having an end (a left end in FIG. 7) in the stroke direction being connected with a magnet 67, and a control part 68. The control part 68 of the servo valve 60 is electrically connected to the system controller 80 of the vacuum pressure control device 70.

In this servo valve 60, the electromagnetic force generated in the first coil 66A by energization and the magnetic force of the magnet 67 cause the spool 64 to move toward one end side, or first side (a left side in FIG. 7) in the stroke direction within the cylinder 65 and be stopped at an precise position corresponding to the command voltage value. On the other hand, the electromagnetic force generated in the second coil 66B by energization and the magnetic force of the magnet 67 cause the spool 64 to move the other side, or second side (a right side in FIG. 7) in the stroke direction within the cylinder 65 and be stopped at an precise position corresponding to the command voltage value.

Accordingly, when the control part 68 of the servo valve 60 receives a command voltage value Vc from the vacuum pressure control device 70 corresponding to a command signal to the first through third coils 66A-66C, the spool 64 is moved rapidly with high response based on this command voltage value Vc. The spool 64 is then caused to slide in the stroke direction to a predetermined position corresponding to the command voltage value Vc within the cylinder 65 and be stopped at a precise position.

In this servo valve 60, the spool 64 is movable within the cylinder 65 in the stroke direction (the lateral direction in FIG. 7), that is, along a direction of arrangement of the first port 61 and the third port 63 in section, via the second port 62 therebetween.

More specifically, when the spool 64 is stopped at a position on the second side (the right side in FIG. 7) in the stroke direction within the cylinder 65, a passage communicating between the first port 61 and the second port 62 is shut off whereas a passage communicating between the third port 63 and the second port 62 is fully opened. This configuration allows the driving air AR to be rapidly discharged to the discharge passage EX through the second port 62 and the third port 63. When the spool 64 is stopped at a position on the second side (the right side in FIG. 7), the passage between the third port 63 and the second port 62 is shut off whereas the passage between the first port 61 and the second port 62 is fully opened. This configuration allows the driving air AR to rapidly flow to the air chamber AS of the open/close valve 30 through the first port 61 and the second port 62.

Furthermore, the spool 64 can be stopped at a neutral position between the first port 61 and the third port 63 to accurately block part of the first port 61 or the third port 63. This makes it possible to, for example, slightly increase a communication passage between the first port 61 and the second port 62 or a communication passage between the second port 62 and the third port 63 so that a flow rate of the driving air AR flowing from the first port 61 to the second port 62 or a flow rate of the driving air AR flowing from the second port 62 to the third port 63 can be fine controlled with high response and high precision.

Accordingly, the servo valve 60 can rapidly supply the driving air AR flowing in the first port 60 to the air chamber AS of the open/close valve 30 through the second port 62 and rapidly discharge the driving air AR flowing from the air chamber AS into the second port 62 to the discharge passage EX through the third port 63. Further, both the flow rate of the driving air AR flowing in the first port 61 and the flow rate of the driving air AR flowing in the third port 63 can controlled with high accuracy.

In the vacuum pressure control system 1, a valve opening amount, namely, the valve opening degree VL of the open/close valve 30 is controlled by the servo valve 60.

In this embodiment, specifically, when command voltage is a command voltage value Vc=0 (V) as shown as the flow rate characteristics indicated by the dotted line in FIG. 8, the spool 64 is located at the second side in the stroke direction, closing the first port 61 and fully opening the passage communicating between the second port 62 and the third port 63. The driving air AR in the air chamber AS is rapidly discharged to the discharge passage EX through the second port 62 and the third port 63. The open/close valve 30 is thus placed in the valve closed state.

In the case of the command voltage value Vc=5 (V), the spool 64 is stopped, as shown in FIG. 7, at a position to close the passage communicating between the first port 61 and the second port 62 and the passage communicating between the third port 63 and the second port 62.

In the case of the command voltage value Vc=10 (V), the spool 64 is stopped at a position on the first side (the left side in FIG. 7) in the stroke direction, closing the third port 63 and opening the communication between the first port 61 and the second port 62. Thus, the driving air AR is rapidly supplied to the air chamber AS and the open/close valve 30 is placed in the opened state with the maximum opening degree VL.

When the command voltage value Vc is larger than 0 (V) but smaller than 5 (V) (0<Vc<5), the flow rate of the driving air AR flowing from the second port 62 to the third port 63 decreases as the command voltage value Vc becomes larger. When the command voltage value Vc is larger than 5 (V) but smaller than 10 (V) (5<Vc<10), the flow rate of the driving air AR flowing from the first port 61 to the second port 62 increases as the command voltage value Vc is larger.

Herein, an explanation will be given to a method of controlling the servo valve 60 by the vacuum pressure control device 70.

In the vacuum pressure control system 1, a measured value of the vacuum pressure in the vacuum chamber measured by the pressure sensor 12 is fed back to the vacuum pressure control circuit 83. This vacuum pressure measured value is compared with the vacuum pressure command value and then a valve opening degree command value obtained by this comparative calculation is outputted. Successively, as to the valve opening degree VL of the open/close valve 30, a displacement detection signal (a measured value of the valve opening degree VL) of the displacement sensor 51 is fed back to the valve opening degree control circuit 84 in which the signal is compared with the valve opening degree command value and inputted to the proportional circuit 85, the integration circuit 86, and the differentiation circuit 87 in the valve opening degree control circuit 84. Then, command voltage controlled in the valve opening degree control circuit 84 is applied as a command signal for the servo valve 60 to the control part 68 of the servo valve 60 through the drive circuit 101.

Meanwhile, in the servo valve 60, the spool 64 is caused to slide within the cylinder 65 to a predetermined position based on the command signal and stopped therein. In the servo valve 60, a slight clearance is provided between the outer periphery of the spool 64 and the inner surface of the cylinder 65.

Such clearance may cause problems even when the command signal to close the open/close valve 30 is inputted to the control part 68 of the servo valve 60 so that the spool 64 is accurately stopped in a position to close the passage communicating between the first port 61 and the second port 62 and the passage communicating between the second port 62 and the third port 63 respectively. For example, the driving air AR leaking from the first port 61 through the clearance may flow in the second port 62. Accordingly, the open/close valve 30 will not be closed completely and will be opened by the driving air AR leaking in the second port 62. Or the driving air AR leaking from the second port 62 through the clearance may flow in the third port 63, thereby closing the open/close valve 30. Thus, even through the process gas is required to be sealed at a predetermined vacuum pressure value in the vacuum chamber 11, the open/close valve 30 will be opened by the driving air AR leaking in the third port 63.

As above, when the valve opening degree VL of the open/close valve 30 is controlled by the servo valve 60, even if the command signal to close the valve 30 is inputted to the servo valve 60, the driving air AR may flow in the clearance between the outer periphery of the spool 64 and the inner surface of the cylinder 65 in the servo valve 60. A leakage amount of the driving air AR at that time is so slight as not to cause any problem in use as a normal valve.

However, in the vacuum pressure control system 1, the open/close valve 30 is opened and closed by the movement of the piston 41 and the sliding resistance of the piston 41 is low by the bellofram 50 provided to enhance the opening and closing response of the open/close valve 30. Therefore even slight leakage of the driving air AR within the servo valve 60 is likely to cause the piston 41 to move. The open/close valve 30 is thus instantaneously opened at the start of control and the gas in the vacuum chamber 11 is sucked by the vacuum pump 15, leading to a decrease in vacuum pressure of this gas (the vacuum pressure value changes to a higher level). Or the open/close valve 30 is caused to repeat opening and closing at relatively higher frequencies than necessary and hence the valve opening degree VL of the valve 30 could not be controlled accurately. As a result, a problem may occur that the vacuum pressure of the process gas sealed in the vacuum chamber 11 could not be controlled to accurately coincide with a predetermined vacuum pressure value.

In the vacuum pressure control system 1, however, the vacuum pressure control device 70 is provided with the teaching program. This teaching program is configured to control so that a difference between the flow rate of driving air AR flowing between the first and second ports 61 and 62 and the flow rate of driving air AR flowing between the second and third ports 62 and 63 becomes relatively zero, and detect and store a teaching command voltage value (a servo valve command signal) outputted to the servo valve 60 when the open/close valve 30 is opened from the full closed state to a predetermined opening degree VL (a threshold value VLth). Based on this teaching command voltage valve, the motion of the spool 64 of the servo valve 60 is controlled.

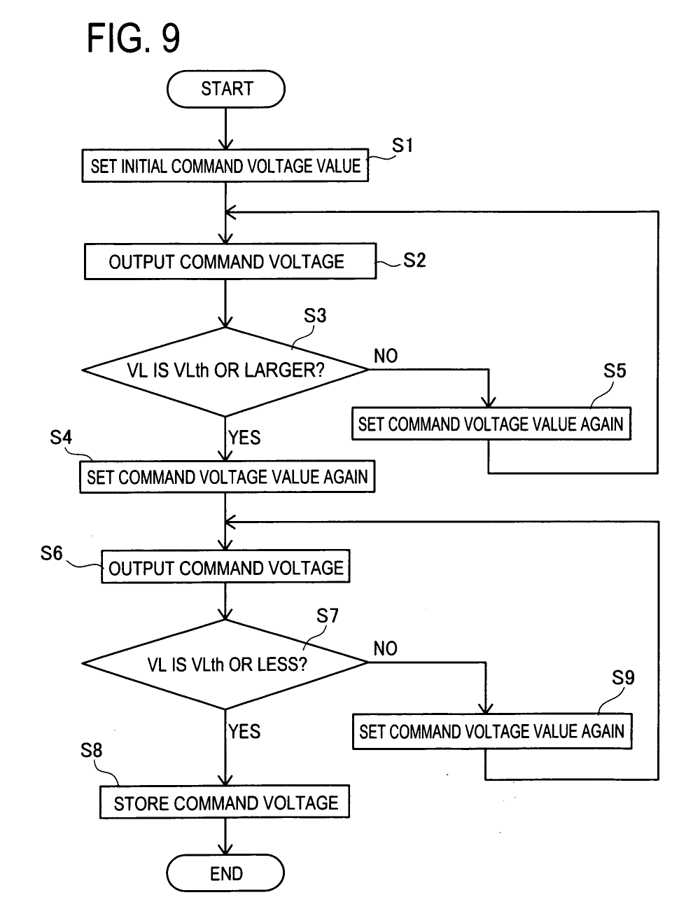

The following explanation will be made on a control method of the servo valve 60 using the teaching program referring to FIGS. 8 and 9. FIG. 9 is a flowchart showing a technique of controlling operations of the servo valve 60 under the teaching program configured in the vacuum pressure control device 70.

The servo valve 60 is first in an initial state where the spool 64 is ready to move as soon as command signal is applied to the control part 68.

In step S1, a command voltage value Vc of command voltage corresponding to the state where driving air AR is not supplied to the air chamber AS of the open/close valve 30 and the open/close valve 30 is in the closed state is set as an initial command voltage value. Specifically, the command voltage value Vc=0 (V) is the initial command voltage value. When the command voltage value VC is 0 (V), the spool 64 is moved to stop at a position for fully opening the passage communicating between the second and third ports 62 and 63 but for blocking the passage communicating between the first port 61 and the second port 62. In other words, driving air AR is not allowed to flow from the first port 61 to the second port 62 but is allowed to flow from the second port 62 to the third port 63.

In step S2, the command voltage to be applied to the servo valve 60 from the vacuum pressure control device 70 is gradually increased from the initial command voltage value (voltage value Vc=0). As the command voltage value Vc increases, the spool 64 is moved to the first side (the left side in FIG. 7) in the stroke direction and the sectional area of the passage communicating between the second port 62 and the third port 63 will decrease. That is, the flow rate of driving air AR allowed to flow in the passage between the second port 62 and the third port 63 is decreased.

In step S3, subsequently, it is determined whether or not the valve opening degree VL of the open/close valve 30 is the threshold value VLth or larger. If the valve opening degree VL is the threshold value VLth or larger (VL≧VLth), the process advances to step S4. The threshold value VLth represents an open position of the open/close valve 30 at a predetermined opening degree such as a state just after valve opening.

When the valve opening degree VL is the threshold value VLth or larger, the spool 64 is moved to fully block the passage communicating between the second port 62 and the third port 63 and simultaneously allow the passage communicating between the first port 61 and the second port 62 to begin to be opened as the command voltage value Vc increases. As soon as this passage begins to be opened, the control of increasing the command voltage value Vc is stopped and this command voltage value Vc is stored as a first detection command voltage value in the microcomputer.

When the condition that the valve opening degree VL is the threshold value VLth or larger (VL≧VLth) is not satisfied, the command voltage value Vc is set again to achieve the valve opening degree VL equal to or larger than the threshold value VLth in step S5. Returning to step S2, the command voltage is increased up to the newly set command voltage value Vc.

In step S4, a command voltage value Vc smaller than the first detection command voltage value is set again so that the spool 64 is moved toward the second side (the right side in FIG. 7) in the stroke direction based on this set command voltage value Vc, to a position just before opening of the passage communicating between the second port 62 and the third port 63.

In step S6, the command voltage applied to the servo valve 60 is gradually decreased down, from the first command voltage value to the command voltage value Vc set in step S4. As this decrease in command voltage value Vc, the spool 64 is moved to the second (the right side in FIG. 7) in the stroke direction, closing the passage communicating between the first port 61 and the second port 62.

In step S7, it is determined whether or not the valve opening degree VL of the open/close valve 30 is the threshold value VLth or less. If the valve opening degree VL is the threshold value VLth or less (VL≦VLth), the process advances to step S8.

When the valve opening degree VL becomes the threshold value VLth or less, the spool 64 blocks the passage communicating between the first port 61 and the second port 62 while begins to open the passage communicating between the second port 62 to the third port 63 again.

When the condition that the valve opening degree VL is the threshold value VLth or less (VL≦VLth) is not satisfied, the command voltage value Vc is set again to achieve the valve opening degree VL equal to or smaller than the threshold value VLth in step S9. Returning to step S6, the command voltage is decreased down to the newly set command voltage value Vc.

In step S8, when the passage communicating the second port 62 and the third port 63 begins to open by the spool 64 moved to the position corresponding to the command voltage value Vc set in step S4, this command voltage value Vc is stored as a second detection command voltage value in the microcomputer. Specifically, this second detection command voltage value is a teaching command voltage value Vct in the flow rate characteristics indicated by the solid line in FIG. 8. This teaching command voltage value Vct is stored in the microcomputer.

As above, the command voltage value Vc to be outputted to the servo valve 60 is controlled so that the difference in flow rate between the driving air AR flowing between the first port 61 and the second port 62 and the driving air AR flowing between the second port 62 and the third port 63 becomes relatively zero. The teaching command voltage value Vct is detected when the valve opening degree VL of the open/close valve 30 is changed from the full closed state to the threshold value VLth. Based on this teaching command voltage value Vct, the movement of the spool 64 is controlled. Thus, the valve opening degree VL of the open/close valve 30 becomes equal to VLth.

In the vacuum pressure control system 1 in the present embodiment, the opening degree VL of the open/close valve 30 is changed by the driving air AR supplied from the air supply source 20 to control the vacuum pressure in the vacuum chamber 11. This control of valve opening degree VL of the open/close valve 30 is executed by use of the servo valve 60.

The servo valve 60 can rapidly supply driving air AR to the air chamber AS through the first port 61 and the second port 62 and rapidly discharge driving air AR through the second port 62 and the third port 63, and can finely control the flow rates of driving air AR flowing between the first port 61 and the second port 62 and between the second port 62 and the third port 63 with high response and high accuracy.

When the driving air AR used to change the valve opening degree VL of the open/close valve 30 is controlled by the servo valve 60, the gas can be rapidly supplied to and also quickly discharged from the vacuum chamber 11 with high accuracy. It is further possible to accurately and rapidly perform fine control of the amount of gas to be supplied to the vacuum chamber 11 and the amount of gas to be discharged from the vacuum chamber 11.

In the conventional vacuum pressure control system, it would take over ten seconds to perform rapid supply/discharge of gas by the electromagnetic valve and fine control of the vacuum pressure of gas in the vacuum container by the electro-pneumatic valve with the poppet valve element that is able to open and close at high frequencies. On the other hand, the vacuum pressure control system 1 in this embodiment enables discharge of a process gas in short time, e.g., one or two seconds, from introduction of a purge gas in the vacuum chamber 11.

The vacuum pressure control system 1 of this embodiment can be a system suitable for e.g. a semiconductor manufacturing process or the like using the ALD process which requires discharging of a process gas in one or two seconds from introduction of a purge gas in a vacuum chamber.

In the vacuum pressure control system 1 of this embodiment, the vacuum pressure control device 70 includes the teaching program configured to detect and store the teaching command voltage value Vct to be outputted to the servo valve 60.

As above, the difference in flow rate between the driving air AR flowing from the second port 62 of the servo valve 60 to the open/close valve 30 and the driving air AR flowing from the open/close valve 30 to the second port 62 is controlled in advance. The operation of the servo valve 60 is controlled based on the teaching command voltage value Vct obtained when the open/close valve 30 is adjusted from the closed state to the predetermined valve opening degree VLth. Accordingly, even if the driving air AR leaks through the clearance between the outer periphery of the spool 64 and the inner surface of the cylinder 65, the valve opening degree VL of the open/close valve 30 can be controlled accurately. The open/close valve 30, that is, the poppet valve element 33A can therefore be placed in a correct open position with high accuracy.

In the case where the vacuum pressure control system 1 of the present embodiment is installed in a factory or plant, for example, the use environment of the system 1 such as pipe length and pipe diameter for flowing the driving air AR from the air supply source 20 to the servo valve 60 and the amount of driving air AR to be supplied from the air supply source 20 to equipment other than the vacuum pressure control system 1 differs depending on usage purposes. Accordingly, the amount of driving air AR leaking within the servo valve 60 is different between the systems 1 according to the usage purposes. The reference valve position of the open/close valve 30 is slightly different between the systems 1.

In the vacuum pressure control system 1 of this embodiment, however, the vacuum pressure control device 70 includes the teaching program. Even after the system 1 is installed in a production line or the like in the factory or plant where the system is actually operated, an optimum teaching command voltage value Vct suitable for the use environment of the system 1 can be detected and stored prior to actual operation so that an adequate operating condition of this system 1 is obtained in advance under the same condition as in the actual operation.

The vacuum pressure control system 1 of this embodiment further includes the displacement sensor 51 for measuring the valve opening degree VL of the open/close valve 30 in noncontact relation. In measuring the vacuum opening degree VL of the valve 30, friction resulting from the contact between part of the displacement sensor 51 and the valve 30 will not occur. Thus, a trouble due to contact failure of the displacement sensor 51 will not be caused by abrasion powder resulting from friction. Accordingly, the valve opening degree VL of the open/close valve 30 can be measured appropriately by the displacement sensor 51.

In the vacuum pressure control system 1 of this embodiment, the open/close valve 30 is provided with the pressure sensor 52 in the air chamber AS which receives driving air AR for driving the piston 40. This pressure sensor 50 serves to check whether or not driving air AR is being supplied from the air supply source 20 to the air chamber AS.

Additionally, the pressure detection signal representing the pressure of the driving air AR in the air chamber AS detected by the pressure sensor 52 is fed back to the valve opening degree control circuit 84 of the system controller 80 and the drive circuit 101 of the air pressure controller 100 in the vacuum pressure control device 70. The valve opening degree control signal corrected by the servo-valve drive correction control circuit 91 of the valve opening degree control circuit 84 is inputted to the control part 68 of the servo valve 60 through the drive circuit 101 of the air pressure controller 100.

Even where the driving air AR in the air chamber AS varies in pressure beyond the supply pressure of 0.35 MPa, the servo valve 60 can be controlled appropriately as above without adversely affecting the control of the valve opening degree VL. The valve opening degree VL of the open/close valve 30 can therefore be controlled adequately.

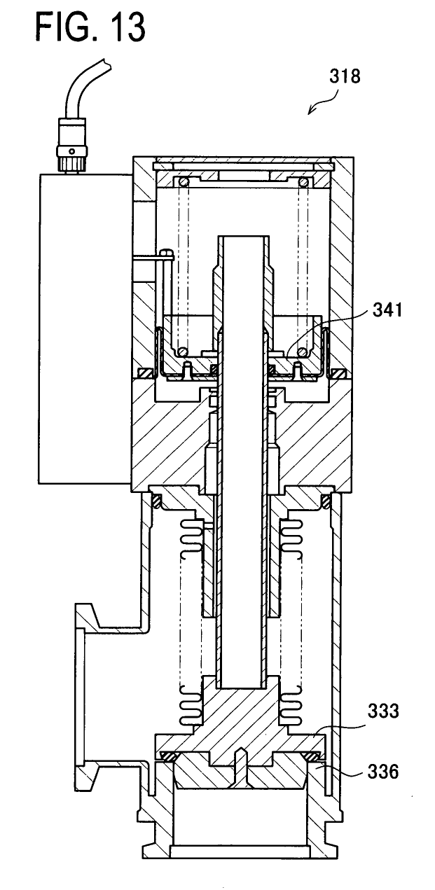

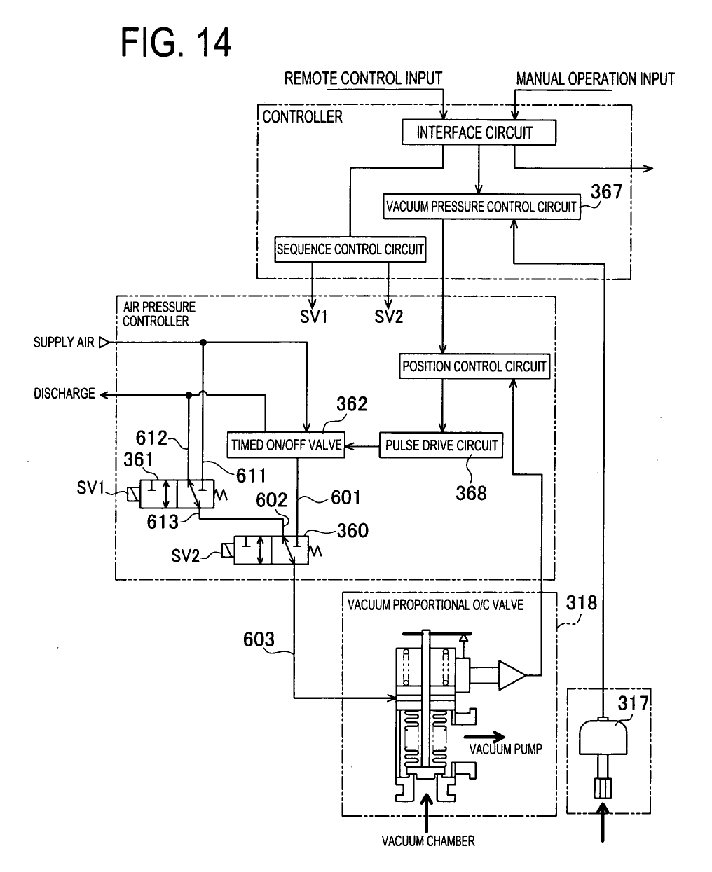

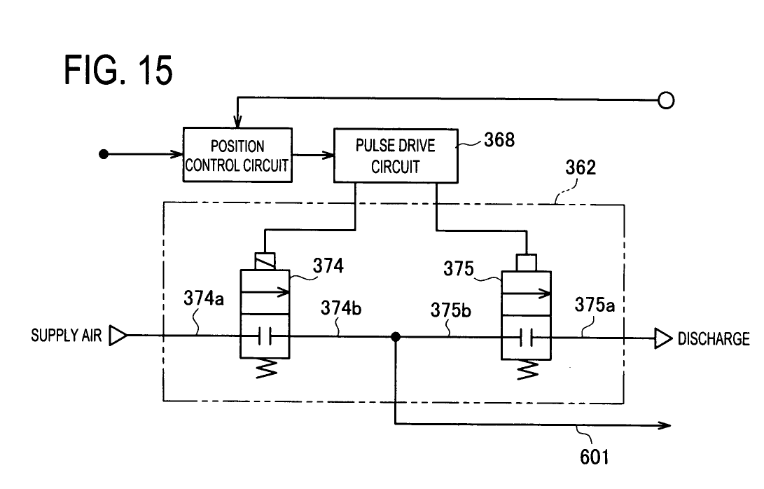

Here, as to the advantages of the vacuum pressure control system 1 of this embodiment, the following two examinations were conducted by comparing with the conventional vacuum pressure control system (see FIGS. 7, 13, and 15).

A first examination was made by comparing required times for the vacuum pressure control system 1 and the conventional vacuum pressure control system to change the poppet valve elements 33A and 333 of the vacuum open/close valves 30 and 318 from the open position with a maximum valve opening degree to the closed position. FIG. 10 is a graph showing the required times to close the poppet valve elements 33A and 333 in the first examination.

The first examination was performed under the following conditions.

(i) In the vacuum pressure control system 1, a maximum valve opening degree VL of the open/close valve 30 is set to 42 (mm). In the conventional vacuum pressure control system, a maximum valve opening degree VL of the vacuum open/close valve 318 is set to 32 (mm).

(ii) In the vacuum pressure control system 1, the supply pressure value of driving air AR for controlling the valve opening degree VL of the open/close valve 30 is set to 0.35 (MPa). In the conventional vacuum pressure control system, the supply pressure value of driving air AR for controlling the valve opening degree VL of the vacuum open/close valve 318 is set to 0.55 (MPa).

(iii) In changing the valve opening degree, a time-lag (t) of a program in the vacuum pressure control device 70 and others is about 0.05 (sec) in both the vacuum pressure control system 1 and the conventional vacuum pressure control system.

The results of the first examination are shown in FIG. 10.

These results reveal that the vacuum pressure control system 1 required a time (t) of about 0.36 (sec) to change the poppet valve element 33A from the full open position to the closed position and the conventional control system required a time (t) of about 1.05 (sec) to change the poppet valve element 318 to the closed position.

Even though the valve opening degree VL of the vacuum pressure control system 1 is larger than that of the conventional vacuum pressure control system, the poppet valve element 33A of the system 1 could be closed in shorter time than the conventional system. This reason is as follows.

In the conventional vacuum pressure control system, the first and second electromagnetic valves 360 and 361 and the timed on/off valve 362 having a smaller gas passage effective sectional area than the valves 360 and 361 are used for control and therefore the time required to close the vacuum open/close valve 318 was so long.

In the vacuum pressure control system 1, on the other hand, the servo valve 60 is used to control the valve opening degree VL of the open/close valve 30. When the poppet valve element 33A is to be changed from the full open position to the closed position, the third port 63 of the servo valve 60 is fully opened. Accordingly, the driving air AR in the air chamber AS can be rapidly discharged to the discharge passage EX through the second port 62 and the third port 63.

In the vacuum pressure control system 1, the valve opening degree VL of the open/close valve 30 can be changed by a minimum pressing force of driving air AR supplied at a pressure of 0.35 MPa required to overcome the urging force of the return spring 42. Consequently, there is no time needed for discharging driving air AR until the pressing force of the driving air AR decreases less than the urging force of the return spring 42, i.e., no wasting time due to discharge.

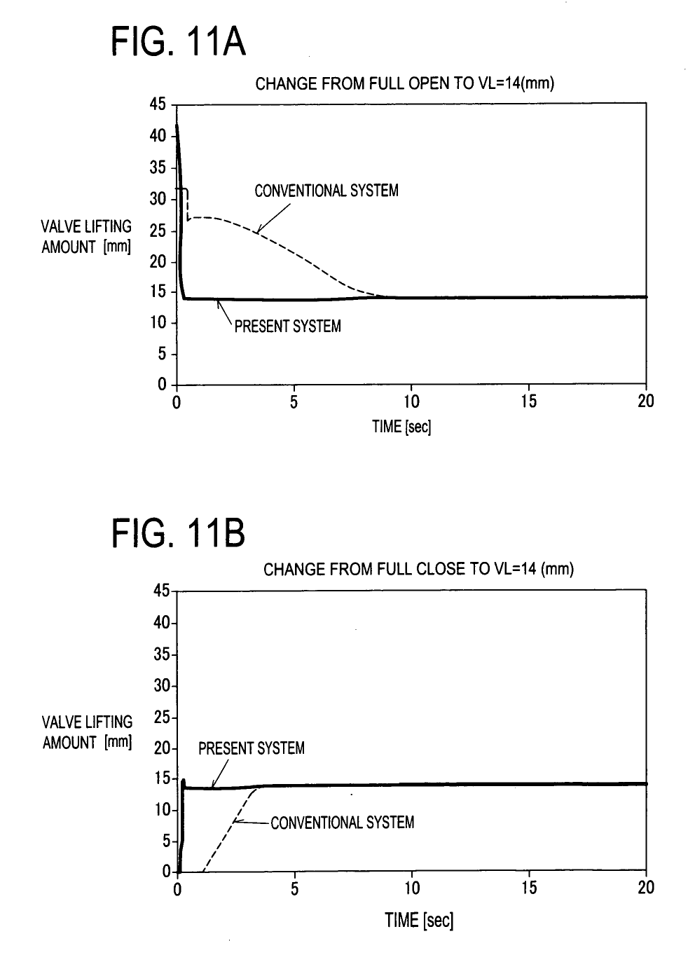

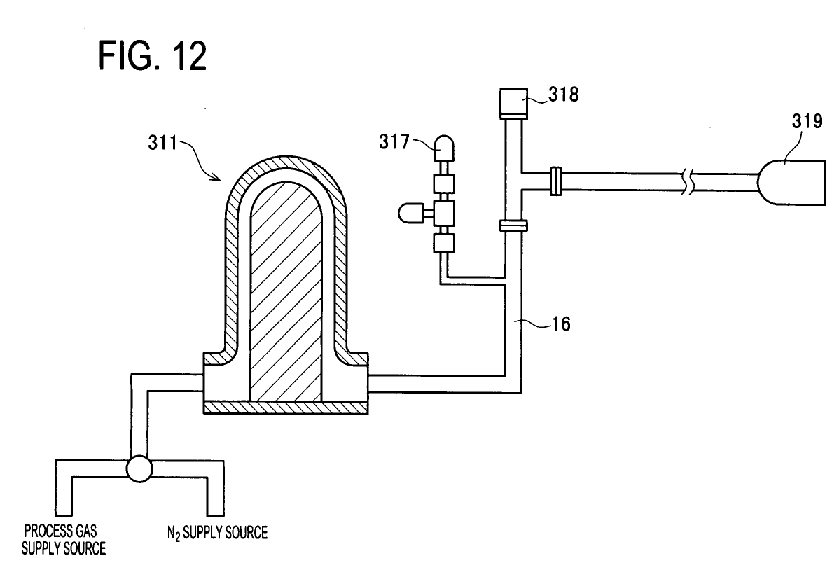

A second examination included a test made by comparing required times for the vacuum pressure control system 1 and the conventional vacuum pressure control system to change the poppet valve elements 33A and 333 of the vacuum open/close valves 30 and 318 from the full open position with a maximum opening degree to an opening degree VL=14 (mm). FIG. 11A is a graph showing the time required for changing the valve opening degree VL of the vacuum open/close valve from the full open position to 14 mm. The second examination also included another test conducted by comparing the required times for changing the valve opening degrees of the poppet valve elements 33A and 333 of the vacuum open/close valves 30 and 318 from the closed position to the opening degree VL=14 (mm). FIG. 11B is a graph showing the time required for changing the opening degree of the vacuum open/close valve from the closed position to 14 mm. The conditions of the second examination were the same as those of the first examination.

The results of the second examination are shown in FIGS. 11A and 11B.

According to the former test of the second examination in which the valve opening degree VL was changed from the full open position to VL=14 mm, as shown in FIG. 11A, the conventional vacuum pressure control system required a time (t) of about 9.0 seconds to move the poppet valve element 333 to VL=14 (mm). On the other hand, the vacuum pressure control system 1 of the present embodiment required a time (t) of about 0.2 second to change the poppet valve element 33A from the full open position to VL=14 (mm).

According to the latter test in which the valve opening degree VL was changed from the full closed position to VL=14 (mm), as shown in FIG. 11B, the conventional vacuum pressure control system required a time (t) of about 3.50 seconds to move the poppet valve element 333 to VL=14 (mm). On the other hand, the vacuum pressure control system 1 of the present embodiment required a time (t) of about 0.2 second to change the poppet valve element 33A from the full closed position to VL=14 (mm).

As clearly from the above results, the time required for changing the valve opening degree VL is different between the vacuum pressure control system 1 and the conventional vacuum pressure control system.

The reason thereof is as follows. In the conventional vacuum pressure control system, when the gas sealed in the vacuum chamber 311 is to be controlled to a target vacuum pressure value, the first and second electromagnetic valves 360 and 361 are first operated to rapidly supply/discharge the gas in/from the vacuum chamber 311 so that the vacuum pressure approaches close to the target vacuum pressure value. In the vacuum chamber 311 in which the gas is sealed, the vacuum pressure value measured by the pressure sensor 317 (a measured value) is different from the vacuum pressure value set as the target value (a set value). This needs further fine control of the vacuum pressure by the timed on/off valve 362. However, such fine control takes long.

In the vacuum pressure control system 1, on the other hand, the valve opening degree VL of the open/close valve 30 is controlled by use of the servo valve 60. This servo valve 60 is able to rapidly supply driving air AR to the air chamber AS of the open/close valve 30 through the second port 62 and rapidly discharge the driving air AR flowing from the air chamber AS into the second port 62 to the discharge passage EX through the third port 63. It is further possible to quickly and accurately control both the flow rate of driving air AR flowing in the first port 61 and the flow rate of driving air AR flowing in the third port 63 including the respective leakage amounts. In other words, the use of the servo valve 60 enables rapid flow rate control in a wide range from a relatively small amount to a large amount of the driving air AR flowing between the air chamber AS of the open/close valve 30 and the servo valve 60.

In the vacuum pressure control system 1, as mentioned above, the valve opening degree VL of the open/close valve 30 is controlled by the servo valve 60. It is therefore possible to rapidly maintain the gas supplied to the vacuum chamber 11 at an accurate vacuum pressure value and also rapidly discharge this gas out of the vacuum chamber 11.

Consequently, the vacuum pressure control system 1 can be achieved as a vacuum pressure control system applicable to the surface treatment technique using the ALD process for replacing a process gas and a purge gas and in shorter time, for example, in one or two seconds.

The present invention is not limited to the above embodiment and may be embodied in other specific forms without departing from the essential characteristics thereof.

For instance, the above embodiment exemplifies the servo valve 60 configured such that the spool 64 is movable in the stroke direction while sliding within the cylinder 65 without rotating on its axis. Alternatively, the servo valve may be configured such that a valve element such as a spool rotates on its axis in controlling a fluid flow rate.

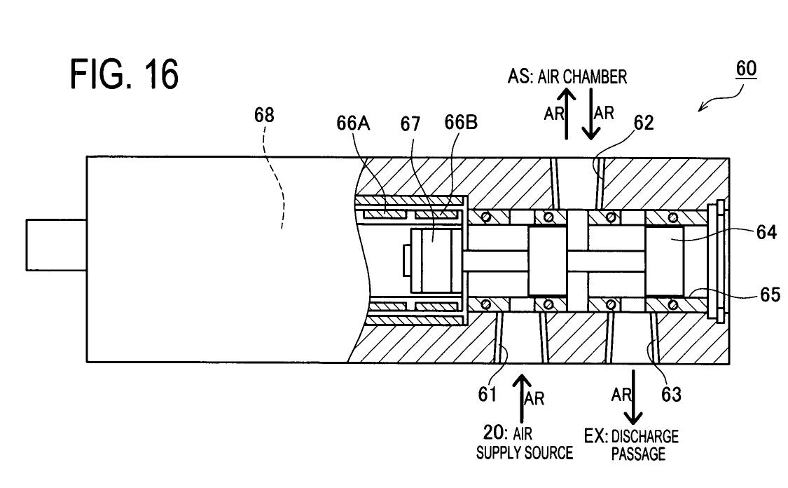

In the above embodiment, for instance, when a drive power source of the servo valve 60 fails or is shut down, the spool 64 is stopped in the position shown in FIG. 7. In this state of the spool 64, the driving air AR is leaking from the first port 61 to the second port 62 and thus the driving air AR may enter the air chamber AS of the open/close valve 30, causing malfunction of the valve 30. To prevent such defect, the servo valve 60 may be arranged to stop the spool 64 in a position shown in FIG. 16 when the drive power source of the servo valve 60 fails or is shut down. In this state, the second port 62 and the third port 63 continuously communicate with each other. Accordingly, even if the driving air AR leaks from the first port 61 toward the second port 62, the leaking driving air AR is made to flow to the third port 63 and will not flow into the second port 62. Consequently, malfunction of the open/close valve 30 can be prevented.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A vacuum pressure control system comprising:
a vacuum container;
a vacuum pump for sucking gas from the vacuum container;
a vacuum open/close valve connected between the vacuum container and the vacuum pump and adapted to control vacuum pressure in the vacuum container by changing an opening degree by a fluid to be supplied from a fluid supply source serving as a power source;
a vacuum pressure control device for controlling the vacuum open/close valve; and
a servo valve for controlling the opening degree of vacuum open/close valve.

2. The vacuum pressure control system according to claim 1, wherein the servo valve includes a first port connected to the fluid supply source, a second port connected to the vacuum open/close valve, and a third port connected to a discharge passage, and
the vacuum pressure control device is adapted to store, as a zero command signal value, a servo valve command value at which a difference between a flow rate of the fluid flowing from the first port to the second port and a flow rate of the fluid flowing from the second port to the third port becomes zero.

3. The vacuum pressure control system according to claim 2, including a teaching program for detecting the zero command signal value when the vacuum pressure control system is installed in a production line where the system will be actually operated.

4. The vacuum pressure control system according to claim 3, wherein the vacuum pressure control device is adapted to output the servo valve command signal based on the stored zero command signal value to control the servo valve.

5. The vacuum pressure control system according to claim 1, wherein the vacuum open/close valve includes:
a valve seat;
a valve element that is movable into or out of contact with the valve seat by the fluid supplied from the fluid supply source to change the opening degree in valve opening and closing directions; and
an elastic member that urges the valve element to the valve closing side,
the opening degree is changed by a minimum pressing force of the fluid required to overcome an urging force of the elastic member.

6. The vacuum pressure control system according to claim 1, further comprising a fluid passage stop valve for stopping the fluid from flowing from the fluid supply source into the servo valve when the vacuum pressure control system is in an nonoperating state.

7. The vacuum pressure control system according to claim 1, wherein the vacuum open/close valve includes a valve opening adjustment part for manually controlling the opening degree of the vacuum open/close valve without use of the servo valve.

8. The vacuum pressure control system according to claim 1, further including a displacement sensor for measuring the opening degree of the vacuum open/close valve in noncontact relation.

9. The vacuum pressure control system according to claim 1, wherein the vacuum open/close valve includes:
a valve seat;
a valve element that is movable into or out of contact with the valve seat:
an actuator for moving the valve element according to the fluid supplied from the fluid supply source; and
a pressure sensor for measuring internal pressure of the actuator.
